(19) United States
(12) Patent Application Publication
(10) Pub. No.: US 2003/0217008 A1
(43) Pub. Date: Nov. 20, 2003

(54) Electronic document tracking

(76) Inventors: Millard J. Habegger, Scituate, MA (US); Todd D. Mytkowicz, Duxbury, MA (US); Michael P. Keohane, Brighton, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/370,024

(22) Filed: Feb. 20, 2003

Related U.S. Application Data
(60) Provisional application No. 60/358,188, filed on Feb. 20, 2002.

(51) Int. Cl. G06F 17/60

(52) U.S. Cl. 705/51

(57) ABSTRACT

A system and method for tracking an electronic document includes a document preparation tool that can accept document content and form data, encrypt the content data, provide a document ID, prepare instructions for generating a data input form and package the encrypted data, document ID and instructions in the electronic document. When a user accesses the electronic document, the instructions can display the data input form to the user. A local file containing the document ID and the user ID can be created on the user's computer system and the content can be decrypted and presented to the user. Files on the document can be updated to include the user ID and a listing of the actions taken by the user with respect to the opened document and the data in the local file and document files can be transmitted to a server for storage in a database.

### RELATED APPLICATIONS

This application claims priority to, and incorporates by reference, the entire disclosure of U.S. Provisional Patent Application No. 60/358,188, filed on Feb. 20, 2002.

### BACKGROUND

Networks, such as the Internet, provide users with access to countless documents on nearly every subject imaginable. For example, web-sites such as www.bitpipe.com offer white-papers and other electronic documents on a wide variety of technical topics. User access of these materials is of great interest to marketers. For example, a marketer working for a data storage company may be very interested in contacting a user that downloaded a white paper about new data storage technologies.

To track user access to documents, some web-sites require users to provide information about themselves before accessing a document. The sites can then keep track of which users download particular documents. Unfortunately, such schemes may ignore the freedom with which documents travel after an initial download. For example, after downloading a document from a web-site and finding it of particular interest, a user may e-mail the document to others, post it on an internal company network, and so forth. For instance, a user may forward an electronic sales brochure to their peers or a purchasing committee for further review. Like the user who originally downloaded the document, these “downstream” users are also of great interest to marketers.

### SUMMARY

A computer-based method of tracking access to an electronic document includes obtaining user demographic information from a user when the user initiates access to the document from a user system; recording the user demographic information to a local file on the user system when the user demographic information is new user demographic information; recording access data to a tracking database for the document; and presenting the electronic document to the user. To obtain the user demographic information, the method can include determining if the local file exists; executing instructions in the document to display a form for inputting user demographic information by the user when the local file does not exist; determining if the local file contains demographic information to populate the form when the local file does exist; populating the form with the demographic data from the local file and displaying the form to the user when the demographic information contained in the local file does not fully populate the form; and accepting user input of demographic information to populate the form. The form can be a graphical user interface form, such as a PDF form or a HyperText Markup Language form.

The method can include determining if a network connection between the user system and a server is operable and uploading the access data to the server when the network connection is operable. Uploading can include encoding the access data as eXtensible Markup Language (XML) instructions for transmission to the server via a HyperText Transfer Protocol POST command. When the network connection is not operable, the method can queue the XML instructions for later transmission to the server.

When the user initiates access, the method can determine, prior to obtaining the demographic information, if computer code for presenting the electronic document to the user resides on the user system. If the computer code does not reside on the user system, the method can download instructions for accessing the electronic document to the user system. In presenting the document to the user, the method can decrypt the document content.

The access data can include demographic information, user system information, the time when the user accessed the document and document identification information. The method can also record access data including recording user actions taken with respect to the document once the electronic document is presented to the user. The access data can be recorded to the local file and uploaded to the server when a connection is operable. The access data can include an access history that can be maintained with the document. The access history can contain user identification information, such as an email address provided by the user with the user demographic information. When a document is opened by a new user, the new user identification information can be appended to the access history. The access history can be used by the method to generate a map from the tracking database to trace the chain of users accessing the electronic document.

In one embodiment, a computer system for tracking access to an electronic document can include a tool module to accept client document content data and form data and prepare the electronic document for tracking access to the electronic document, an application module activated by a user accessing the document that can obtain user demographic information, a server that can obtain the user demographic information from the application module, a database accessible to the server to store the user demographic information and an interface for presenting the user demographic data to a client.

The tool module can include an encrypter to encrypt the content data, a form generator to prepare instructions for the application module to present a demographic information input form to the user, an identification module to prepare a document identifier for the electronic document and a packager to assemble the encrypted data, the instructions and the document identifier into the electronic document. The identification module can combine a timestamp and a hash of the content data to prepare the document identifier.

The interface can format the user demographic data for presentation in one of a number of formats, including PDF format, HyperText Markup Language format and Graphical User Interface format. The interface can sort and filter user listings in the database, so as to present different subsets of the user demographic information to the client. The interface can download the listings to the client as a relational database file.

In one embodiment, computer-readable medium can contain instructions for controlling a computer system to prepare an electronic document for tracking of the electronic document. The instructions can control the computer system to receive form data and content data from a client, prepare instructions for generating a data input form based on the form data, package the content data and instructions so as to create the electronic document and assign a document identifier to the electronic document.

The packaging instruction can include instructions to encrypt the content data, associate an application for decrypting the content data with the electronic document and layer the data input form over the encrypted content data to display the data input form until user inputs to the form are obtained. The instructions for assigning a document identifier can include instructions to combine a timestamp and a hash of the content data.

In one embodiment, an electronic document disposed on computer-readable medium and configured for tracking access to the document can include encrypted content, a document identifier, an access history file and computer code for presenting a data input form to a user accessing the document. The data input form can be layered on the content to prevent access to the content until the user inputs the data to the form. The document identifier can include a timestamp and a content hash. The document can also include computer code for downloading an application for decrypting the content. The access history file can include a listing of users accessing the document. The listing can include user demographic data taken from user inputs to the data input form.

### BRIEF DESCRIPTION OF THE DRAWINGS

FIG. 1 is a diagram illustrating operation of a system that tracks user access to an electronic document.

FIG. 2 is a diagram illustrating a sample implementation of the system.

FIG. 3 is a flow-chart of a process for configuring a document for use with the system of FIG. 1.

FIG. 4 is a flow-chart of a process for tracking access to an electronic document.

### DETAILED DESCRIPTION

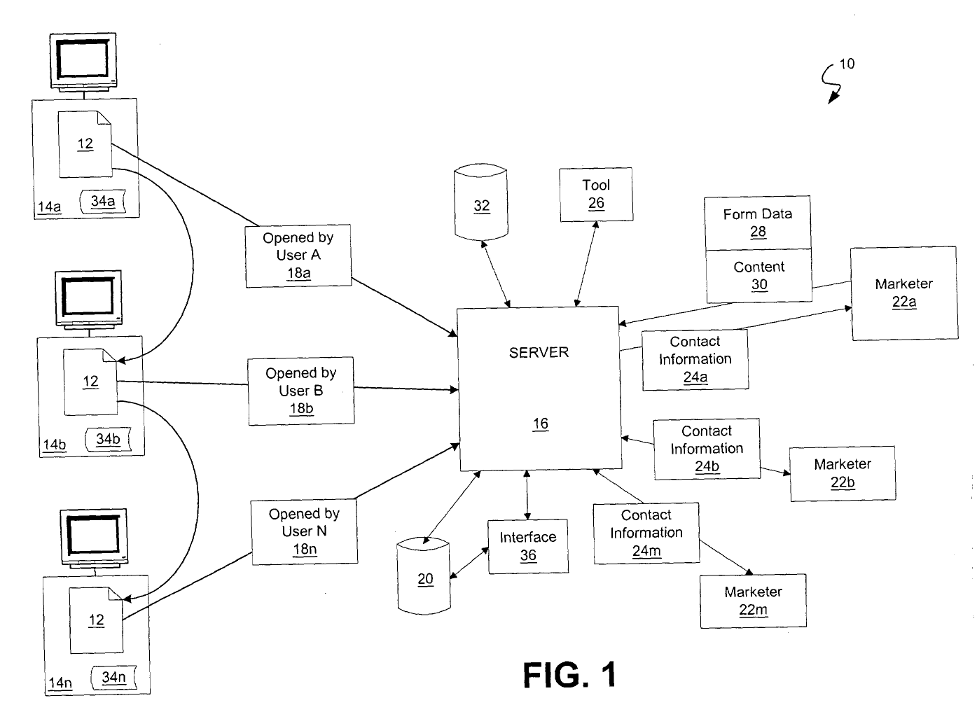

FIG. 1 illustrates a system 10 that can track access to an electronic document 12 as different users access the document 12 and pass it along. As shown, computers 14a-14n notify a server 16 of user access to the document 12 by transmitting a message 18a-18n over a network such as the Internet. The message 18a-18n can identify the user (e.g., e-mail address, and/or other demographic information), the computer 14a-14n (e.g., IP address) providing access, identification of the document 12, and/or other information. When a message is received, server 16 can store the information in the message in a database 20.

From the information received and stored by the server 16, marketers 22a-22m can identify individuals who have opened the marketers' documents. Thus, the marketers 22a-22m can obtain contact information 24a-24m for users that have shown interest in particular information, such as users that read a particular document. As an example, document 12 may be a document that marketer 22a has provided to the system 10. By accessing the information in database 20 through server 16, marketer 22a can obtain contact information 24a for users A-N. The information can also be used to automatically generate a map tracing the trail of the document 12 as it travels to different users and computers. Such a map can identify users that regularly disseminate documents 12 to others.

Interface 36 can present the contact information to a marketer in a variety of formats, including PDF format, HTML (HyperText Markup Language) format, and/or other GUI (Graphical User Interface) formats. The contact information can include listings of users that have accessed the marketer's documents. The listings may be sorted and filtered by user to provide different views and subsets of data. For example, the listing can be sorted by user showing the documents the user has accessed, or indicating the actions taken by the user with regard to one of the documents. In one embodiment, the marketer can download the listing to a relational database file, such as a Microsoft® Excel® file.

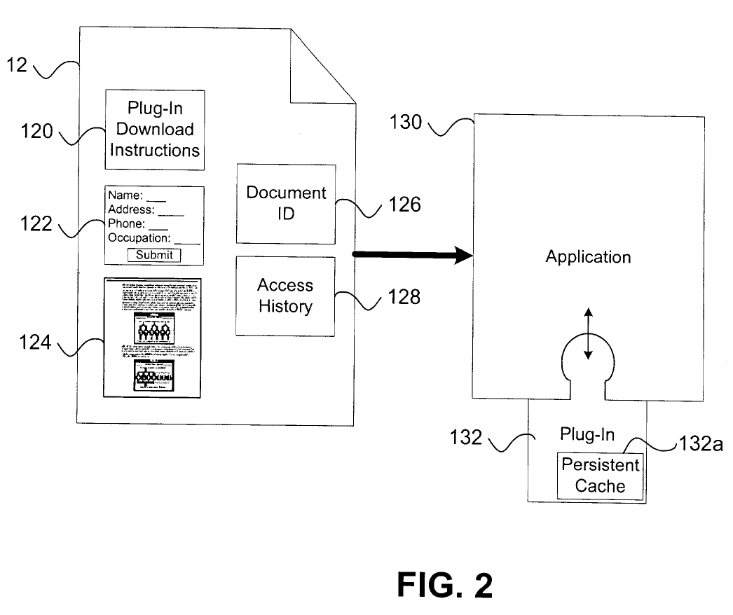

FIG. 2 illustrates a sample implementation of such a system. As shown, an application program 130 accesses a document 12 that includes a document identifier 126 and embedded content 124 of interest to a user (e.g., a marketer's or vendor's white paper or sales brochure). The content 124 may be “scrambled” (e.g., encrypted) to prevent “hackers” from viewing the content without participating in the document tracking scheme. The application 130 (and/or plug-in 132) can extract, “unscramble” (e.g., decrypt), and present the embedded content 124 to a user.

Presentation of the embedded content 124 may be preconditioned on the collection of demographic information from the user. Thus, the document 12 may also include computer code, or instructions 120 for a form 122 that the application 130 can present to a user to interactively collect demographic information such as the user's name, e-mail address, phone number, mailing address, gender, occupation, and so forth. The form 122 may be a PDF form, an HTML (HyperText Markup Language) form, and/or other form that may be generated by GUI (Graphical User Interface) generating instructions. By packaging the form 122 within the document 12, instead of, for example, including a link to web-page hosting the form, the system can collect the information without requiring an active network connection.

The collected demographic information may be transmitted to the server 16, for example, as part of the notification message 18a-18n, as shown in FIG. 1. The application 130 may also store the collected information locally and/or store an indication that this data has been collected, for example, by storing a user identifier (e.g., the computer 14 IP or Ethernet MAC address). The collected information and/or indication may be stored as persistent cache 132a within plug-in 132, also illustrated as local files 34a-34n in FIG. 1. It can be understood that local files 34a-34n may include data files on user computers 14a-14n in addition to persistent cache 132a.

Thereafter, the application 130 need not require the user to re-enter this information. That is, while the user may access the document 12 and many other documents participating in the tracking scheme over time, the user need only be queried for information once. When the user accesses a document configured for the document tracking scheme and the user demographic information and/or user identifier has been previously stored, the application 130 may merely access and resend the users' id or demographic information. The user may be notified or prompted to authorize this transmission.

Potentially, different document forms 122 will identify different information to collect from the user. For example, a first document form 122 may include an “Occupation” field while another may include a “Do you make purchasing decisions?” checkbox. In the event a form 122 requests information not previously collected, the application 130 can populate the form 122 with the previously collected information to reduce the amount of user data entry. The newly collected information may be sent to the server with or without the previously collected information.

As shown, the illustrated document 12 may also include access history 128 data that can identify different users and/or computers 14 that have accessed the document 12. The application 130 may append new information (e.g., user identifier, computer identifier, and/or access time) to the access history 128 upon detecting access by a new user or computer. The access history 128 information, or a portion thereof, may be transmitted to the server 16, for example, to enable marketers to trace the flow of a document 12 amongst individuals.

For the exemplary system and document 12 of FIG. 1, the access history 128 data of document 12 at computer 14a can include the identifier for user A; the access history 128 data of document 12 at computer 14b can include the identifier for user B appended to the user A identifier; and so forth, such that the access history 128 data of document 12 at computer 14n can include the identifier for user N appended to the previous user identifiers. In one embodiment, when the access history 128 information is transmitted to server 16, the access history 128 information retained on document 12 may include only the current user identifier. As an example for this embodiment, after transmission of the access history 128 information of document 12 at computer 14n by message 118n, the access history 128 data of document 12 at computer 14n may include only the identifier for user N.

In addition, the application 130 can track document use and maintain a document use history that can identify user activity for the document. The application 130 may append document use information to a local file, such as files 34a-34n in FIG. 1, which files can include persistent cache 132a. The document use information may identify user actions taken once the document is opened by the user. For example, the document use information can include a page and/or section identifier and a date when the page and/or section was opened. The document use information can also include identifiers for other actions that the user may take while the document is open, such as printing of a page, a section and/or the complete document and copying text from the document. The document use history, or a portion thereof, may also be transmitted to the server 16.

The scheme illustrated in FIG. 2 may be implemented using a variety of document and/or application architectures. For example, the application 130 may be Adobe's Acrobat® or Reader® applications 130 that process Portable Document Format (PDF) documents 12. In this implementation, the different document 12 components may be included as different PDF elements. For example, the embedded content 124, form 122, and access history 128 may be defined as “indirect” objects that a PDF reader application 130 can quickly find within a PDF document 12, e.g., local storage elements such as “Document-Independent Preferences” or “PDF Catalog”. Other information may be included as different kinds of PDF data. For example, the document identifier 126 may be included as an entry in a PDF catalog that stores name/value pairs, such as (“Doc. Id.”,[TimeStamp+ContentHash]), or within the PDF header. The different elements of a PDF document are described in the “PDF Reference” available from Adobe Systems Incorporated

The application 130 may be programmed to include instructions implementing the tracking scheme. For example, Adobe® may offer a version of the Acrobat® or Reader® applications to provide the tracking features described herein. Alternatively, as shown, the functionality described as being performed by application 130 may be performed by or under the control of “plug-in” 132 software. The plug-in 132 receives information from the application 130 such as the occurrence of different events (e.g., document open, close, print, and other user interaction). The plug-in 132 can also control the behavior of the application 130 by invoking methods exposed by the application's 130 Application Programming Interface (API). For example, such methods can include methods that enable the plug-in 132 to “command” the application 130 to process different elements within a PDF document.

As shown, the document 12 may include instructions 120 for presenting the form 122 to the user. The instructions 120 can also include instructions, or computer code, for automatically installing the plug-in 132. For example, the document 12 may be configured to include JavaScript instructions that the application 130 executes/interprets upon opening of the document 12. The instructions 120 may determine whether the plug-in 132 is already present. If not detected, the instructions 120 may automatically initiate plug-in 132 installation. Potentially, the instructions 120 may request user authorization before installing the plug-in 132. Alternatively, or in addition to the instructions 120, the document 12 may include a default display that features a description of the installation process and a link (e.g., www.bitpipe.com/plug-in) that initiates installation of the plug-in 132 upon user activation of the link. Inclusion of the plug-in link and/or instructions 120 minimizes the amount of user effort needed to participate in the tracking scheme.

By packaging components within the document 12, the document 12 essentially brings the tracking system with it wherever it goes. That is, regardless of whether the document 12 is retrieved from a server, e-mailed, transferred by floppy disk, or distributed by some other method, the document 12 includes the components that enable a user to quickly install and participate in the tracking scheme.

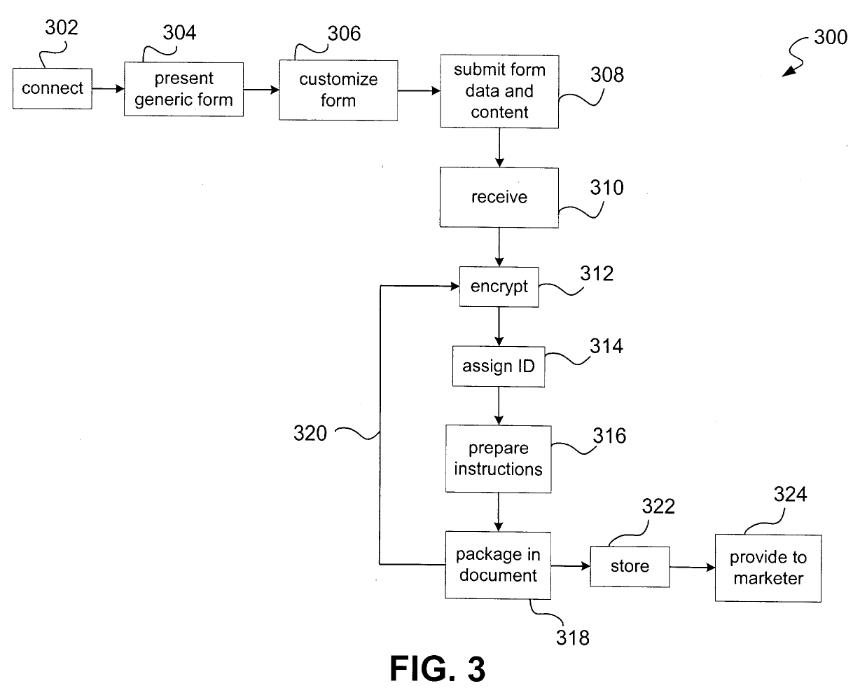

Referring back to FIG. 1, the document 12 can be created with an authoring tool 26 that can receive content and form 122 information from the marketers 22a-22m. Referring now to FIG. 3, tool 26 can be implemented in a process 300. When a marketer, such as marketer 22a, wishes to include a document in the tracking system 10, the marketer 22a can connect 302 with server 16. Server 16 can present 304 the marketer with a generic version of a form 122. The marketer can customize 306 the generic form and can submit 308 the customized form data 18 and the content information 30 for the document to tool 26 via server 16.

Tool 26 can receive 310 the content information 30 and can perform encryption 312 (e.g., Blowfish or MD5) on the content and can assign 314 a document id (e.g., a time-stamp+content hash) to the document. Additionally, the tool 26 can prepare 316 the computer code 120 for presenting the customized form data 28 as form 122 to users who open the document and the computer code for automatically installing the plug-in 132. The tool 26 can then package 318 these encrypted content, document id, computer code and other components within the document 12. The packaging can include layering the form 122 over the content data, such that the contents may not be accessible until the form data has been obtained. When the marketer has multiple documents, tool 26 can prepare multiple documents in a batch mode, as shown by loop 320 in process 300, using the same form data 28, or different documents can have different form data. The prepared documents can be stored 322 in database 32 for downloading by users. Additionally or optionally, the prepared documents can be provided 324 to the marketer for distribution via a web server, email, CD, or other means determined by the marketer.

A wide variety of variations on the system illustrated above are possible. For example, the components and instructions may be distributed in a different manner between the document 12 and the application 130 or plug-in 132 than shown. For example, rather than embedding the form 122 within the document 12, the plug-in 132 may include such instructions. Additionally, while described as operating within Adobe's® PDF architecture, the system may be implemented within a wide variety of other document/application architectures. For example, the document 12 may be a Microsoft® Word® document 12 processed by the Microsoft® Word® application. Alternatively, the document 12 itself can contain application logic in the form of a script, such as the Javascript previously described, which can interact with the viewer or user. The script can be prepared so as to provide the functionality of the plug-in, e.g., “scrambling” the document, and collecting/storing user information, and may replace the plug-in 132.

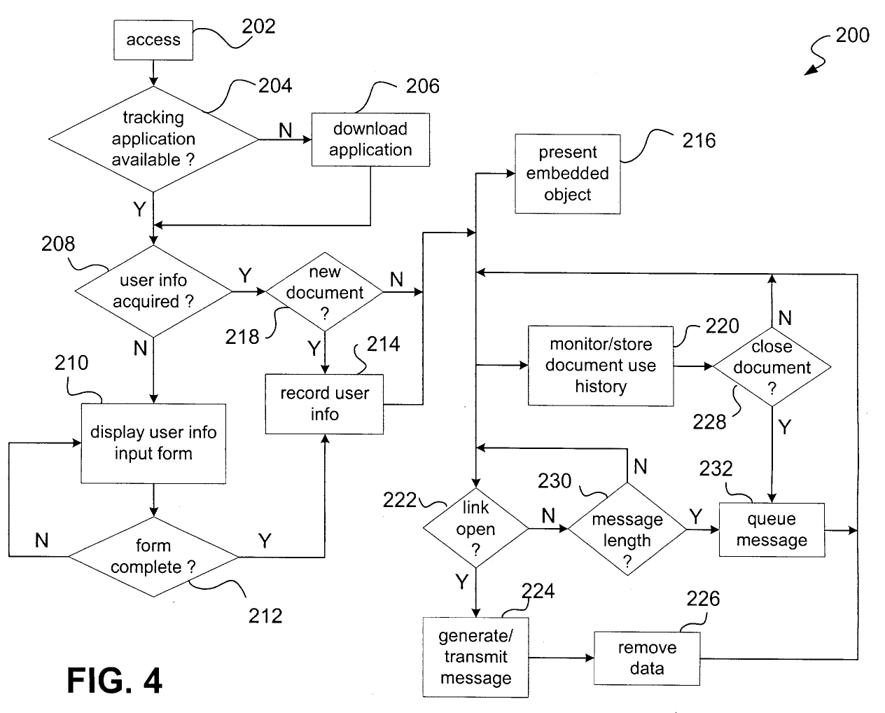

As an example of the implementation of the system 10, the application 130 or plug-in 132 may implement a process 200 shown in FIG. 4. For the embodiment of FIG. 4, the user may attempt to access 202 the document, e.g., by double clicking on an icon representing the document or choosing the file from a menu. The process 200 can determine 204 whether the document is configured for participation in the document tracking scheme. As previously indicated, the document may include instructions that can be executed upon accessing the document so as to determine if the application 130 and/or the plug-in 132 are present to open the document. For example, the instructions may search the computer from which access is being sought for the application and/or plug-in. If the application and/or plug-in are not available, the user can be prompted 206 to download the application and/or plug-in, as previously described.

If the application and/or plug-in are available, the process 200 may determine 208 whether demographic data exists for the form 122 input elements of the document being accessed. For example, the process 200 can verify that data fields of the document form have previously been stored in a local file, such as files 34a-34n shown in FIG. 1. If not, the process 200 can initiate collection of the user information by displaying 210 the form generated by the instructions stored within the document. Once the proper information is obtained, as determined at 212, the data fields of the document form can be stored 214 in the local file and the document content can be presented 216 to the user.

In the exemplary process 200 of FIG. 4, the demographic information may be obtained prior to presenting the document's embedded content to the user. This scheme can encourage user entry of the information since the form may be presented after downloading the document. Thus, a user having invested the time needed to download the document may be more likely to submit the demographic information. In other implementations, receipt of the demographic data may not be a strict pre-requisite to presentation of the embedded content, but may instead be an option for the user. However, the process 200 may be configured to periodically re-inquire whether the user would like to provide such information until the user does so.

As previously noted, the demographic information provided for one document can be applicable to other documents. Thus, a user may need to input some demographic data only once, regardless of the number of tracked documents accessed by the user from one computer. As described previously, the demographic information that clients or marketers may wish to obtain can differ from document to document. Thus, the demographic information in the local file can include generic information common to the forms 122 of the documents the user has opened and can also include other demographic information associated with particular ones of the documents the user has opened. If some of the demographic information for the document the user is accessing is not found in the local file, the form 122 for that document may be presented to the user, with demographic information from the local file populating the form as appropriate. The user can fill in the missing information, or otherwise edit the form. If the local file contains the demographic information for the form 122 of the document being accessed, the embedded content of the document 12 can be presented 216 to the user without presenting the form for user input. If the document is being accessed for the first time by an existing user, as determined at 218, the user's ID from the local file can be recorded 214 to the access history 122 of the document.

While the embedded content is open, process 200 can monitor and store 220 the document use history to the local file, as previously described. Additionally, the process 200 can determine 222 whether a connection to the server 16 is available. If a connection is available, the process 200 can generate and transmit 224, or upload, a message identifying the user, computer, document, time, access history, document use history and/or other information to the server. For example, the user's demographic information may be encoded as XML (eXtensible Markup Language) instructions for transmission to the server via an HTTP (HyperText Transfer Protocol) POST command. The server 16 may feature a web-server (e.g., an Apache web-server) that processes the received HTTP message and stores the received information in a relational database, such as database 20. In one embodiment, the generation of the message 224 may also notify and/or prompt the user to obtain authorization from the user to transmit the message.

If the message is from a new user, server 16 may determine a new user ID, which can be related with the message 224 and stored in database 20. When the message is transmitted to server 16, some information can be removed 226 from the access history 28 and/or from the local file 34a-34n. For example, the process 200 may remove previous user identifiers from access history 28 and may remove the document use data from local file 34a-34n.

If a “close document” operation is detected 228 while monitoring document use at 220, or if the process 200 cannot establish a network connection to the server 16 and the data awaiting transmittal exceeds a predetermined message length, as determined at 230, the process 200 can generate and queue 232 messages in the local file for batch transmission when a network connection can be established while the document is opened. By queuing in the local file, the queued messages can be transmitted when other documents configured for process 200 may be accessed by the user. The queued messages can be removed, as at 226, from the local file once transmitted to server 16.

The process 200 shown in FIG. 4 is merely illustrative and a wide variety of variations are possible. For example, instead of merely obtaining user access and document use information, the process 200 can also obtain a wide variety of information from the user, such as document ratings and comments, which may be included with the demographic information of form 122. The application 130 may provide for user annotations to be made to the document, which may be tracked in the document use history.

The techniques described herein are not limited to any particular hardware or software configuration; they may find applicability in any computing or processing environment. Those with ordinary skill in the art will also recognize that the elements of the Figures can be combined or otherwise rearranged, and that the illustration of components and modules is merely for illustrative purposes. For example, the database demographic information database 20, the document database 32 and/or the tool 26 may be combined with the server 16. In some embodiments, computers 14a-14n and server 16 can be understood to represent part of a client-server model, as can marketers 22a-22m and server 16.

The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

1. A computer-readable medium containing instructions for controlling a computer system to track access to an electronic document by controlling the computer system to:
obtain user demographic information upon initiation of access to the document by the user from a user system;
record the user demographic information to a local file on the user system when the user demographic information is new user demographic information;
record a user identification to an access history file of the document when the user demographic information is new user demographic information, the user identification based on the user demographic information.
record access data to a tracking database for the document; and
present the electronic document to the user.

2. The computer-readable medium of claim 1, wherein obtaining user demographic information comprises:
determining if the local file exists;
executing instructions in the document to display a form to the user when the local file does not exist, the form for inputting user demographic information by the user;
determining if the local file contains demographic information to populate the form when the local file does exist;
populating the form with the demographic data from the local file and displaying the form to the user when the demographic information contained in the local file does not fully populate the form; and
accepting user input of demographic information to populate the form.

3. The computer-readable medium of claim 2, wherein the form is a graphical user interface form, including at least one of a PDF form and a HyperText Markup Language form.

4. The computer-readable medium of claim 2, comprising:
determining if a network connection between the user system and a server is operable; and
uploading the access data to the server when the network connection is operable.

5. The computer-readable medium of claim 4, wherein recording access data further comprises recording user actions taken after the electronic document is presented to the user.

6. The computer-readable medium of claim 4, wherein uploading comprises encoding the access data as eXtensible Markup Language instructions for transmission to the server via a HyperText Transfer Protocol POST command.

7. The computer-readable medium of claim 4, comprising:
encoding portions of the access data as eXtensible Markup Language instructions for transmission to the server via HyperText Transfer Protocol POST commands; and
queuing the eXtensible Markup Language instructions when the network connection is not operable.

8. The computer-readable medium of claim 2, wherein recording access data further comprises recording user actions taken after the electronic document is presented to the user.

9. The computer-readable medium of claim 1, comprising:
determining, prior to obtaining the user demographic information, if computer code for presenting the electronic document to the user resides on the user system; and
downloading the instructions to access the electronic document to the user system when the computer code for presenting the electronic document to the user does not reside on the user system.

10. The computer-readable medium of claim 1, wherein the tracking database resides on at least one of the user system and a remote server in communication with the user system via a network connection.

11. The computer-readable medium of claim 10, comprising:
determining if the network connection is operable; and
uploading the access data to the server when the network connection is operable.

12. The computer-readable medium of claim 11, further comprising:
appending a document ID to the local file when the user is a new user; and
appending a user ID to the access data.

13. The computer-readable medium of claim 11, wherein uploading comprises encoding the access data as eXtensible Markup Language instructions for transmission to the server via a HyperText Transfer Protocol POST command.

14. The computer-readable medium of claim 11, comprising:
encoding portions of the access data as eXtensible Markup Language instructions for transmission to the server via HyperText Transfer Protocol POST commands; and
queuing the eXtensible Markup Language instructions when the network connection is not operable.

15. The computer-readable medium of claim 1, wherein the access data comprises at least one of demographic information, user system information, time of access and document identification information.

16. The computer-readable system of claim 1, wherein recording access data further comprises recording user actions taken after the electronic document is presented to the user.

17. The computer-readable medium of claim 1, wherein presenting the electronic document comprises decrypting the content of the document.

18. The computer-readable medium of claim 1, containing instructions to generate a map from the tracking database to trace at least one chain of users accessing the electronic document.

19. A computer system for tracking access to an electronic document, comprising:
a tool module to accept client document content data and form data and prepare the electronic document for tracking access to the electronic document;
an application module activated by a user accessing the document, the application module obtaining user demographic information;
a server obtaining the user demographic information from the application module;
a database accessible to the server to store the user demographic information; and
an interface for presenting the user demographic data to a client.

20. The computer system of claim 19, wherein the tool module comprises:
an encrypter to encrypt the content data;
a form generator to prepare instructions for the application module to present a demographic information input form to the user;
an identification module to prepare a document identifier for the electronic document; and
a packager to assemble the encrypted data, the instructions and the document identifier into the electronic document.

21. The computer system of claim 20, wherein the identification module combines a timestamp and a hash of the content data to prepare the document identifier.

22. The computer system of claim 19, wherein the interface formats the user demographic data for presentation in one of a PDF format, HyperText Markup Language format and Graphical User Interface format.

23. The computer system of claim 19, wherein the database comprises listings of users accessing documents of the client, the interface sorting and filtering the listings to present different subsets of the user demographic information to the client.

24. The computer system of claim 23, wherein the interface downloads the listings to the client as a relational database file.

25. A computer-readable medium containing instructions for controlling a computer system to prepare an electronic document for tracking of the electronic document, by:
receiving form data and content data from a client;
preparing instructions for generating a data input form based on the form data;
packaging the content data and instructions so as to create the electronic document; and
assigning a document identifier to the electronic document.

26. The computer-readable instructions of claim 25, wherein packaging comprises:
encrypting the content data;
associating an application for decrypting the content data with the electronic document; and
layering the data input form over the encrypted content data to display the data input form until user inputs to the form are obtained.

27. The computer-readable instructions of claim 25, wherein assigning a document identifier comprises combining a timestamp and a hash of the content data.

28. An electronic document disposed on computer-readable medium and configured for tracking access to the document, comprising:
encrypted content;
a document identifier;
an access history file; and
computer code for presenting a data input form to a user accessing the document, the data input form being layered on the content to prevent access to the content until the user inputs the data to the form.

29. The electronic document of claim 28, wherein the document identifier comprises a timestamp and a content hash.

30. The electronic document of claim 28, comprising computer code for downloading an application for decrypting the content.

31. The electronic document of claim 28, wherein the access history file includes a listing of users accessing the document.

32. The electronic document of claim 31, wherein the listing of users accessing the document includes user demographic data taken from user inputs to the data input form.
